(19) United States
(12) Patent Application Publication
(10) Pub. No.: US 2018/0009329 A1
(43) Pub. Date: Jan. 11, 2018

(54) System and Method for Charging Vehicle Batteries

(71) Applicant: Robert Tellez, Fort Worth, TX (US)

(72) Inventor: Robert Tellez, Fort Worth, TX (US)

(21) Appl. No.: 15/205,943

(22) Filed: Jul. 8, 2016

(51) Int. Cl. B60L 11/18; B60L 1/00; B60L 3/12; B60L 11/16; H02N 11/00

(52) U.S. Cl. CPC B60L 11/1861; B60L 3/12; B60L 11/16; B60L 11/1805; B60L 1/003; B60L 2220/20; H02N 11/008; Y10S 415/916; B60L 2220/16

(57) ABSTRACT

A charging system and method for charging a battery of a vehicle is disclosed. The charging system includes a movable member, such as a wind-driven element. The charging system also includes means for exposing the wind-driven element during vehicle deceleration and for covering the wind-driven element during vehicle acceleration and coasting. The charging system further includes electrical power generating means operably associated with the wind-driven element and the battery such that the electrical power generating means provides electrical power for recharging the battery when the electrical power generating means receives mechanical power from the wind-driven element. Alternative embodiments can include a drop-wheel as a movable member.

### BACKGROUND

### 1. Field of the Invention

The present application relates to charging systems for vehicle batteries. In particular, the present application relates to charging systems that include a movable member, such as a wheel or a wind-powered element.

### 2. Description of Related Art

Most self-propelled vehicles, including automobiles, include a battery and a number of electrical systems. Many vehicles, such as automobiles and motorcycles, also include a gas powered engine that provides power for propelling the vehicle. Such vehicles rely on electrical power from the battery for starting the gas engine. Such vehicles also typically include a number of electrical systems, such as lights and radio, which rely on electrical power from the battery. Other vehicles are purely electric vehicles, such as electric cars, golf carts, and the like, which rely on power from the battery for propelling the vehicle, as well as for other electrical systems such as lights and radio that may be provided.

The vehicle battery is typically rechargeable. Vehicles equipped with a gasoline engine usually include an alternator that is driven by the gasoline engine and operable for generating electrical power to recharge the battery. While an alternator provides a useful means for recharging the battery, such vehicles do not typically include any additional or backup charging system in the event of an alternator failure.

Other purely electric vehicles must be charged from an external electrical power source, such as a generator or an AC power outlet. This requires the electric vehicle to be stationary, so the electric vehicle is out of service until the battery is recharged. As a consequence, the range of a typical electric vehicle is limited to the distance the vehicle can be driven before the battery is discharged to the point where the battery can no longer provide sufficient electrical power for propelling the vehicle.

Thus, there exists a need for improved charging systems for vehicle batteries.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 shows a block diagram of a vehicle having a battery bank and a charging system;

FIG. 2 shows a block diagram of an alternative embodiment that includes multiple battery banks;

FIG. 3 shows a block diagram of an alternative embodiment that includes multiple battery banks and multiple drive motors;

FIG. 4 shows a block diagram of an alternative embodiment that includes multiple battery banks, multiple drive motors, and multiple drive systems;

FIG. 5 shows a block diagram of an alternative embodiment that includes a drop-down wheel for the charging system;

FIG. 6 shows a block diagram of a heating system for a vehicle cabin;

FIG. 7 shows a schematic block diagram of an embodiment that includes the use of the rotation of an axle and/or a drive shaft for driving one or more electric generators;

FIG. 8 shows a schematic block diagram of an electric generator that is belt-driven by a rotating drive shaft or axle; and

FIG. 9 shows a schematic block diagram of an electric generator that uses a rotating drive shaft or axle as a stator.

### DETAILED DESCRIPTION OF THE PREFERRED EMBODIMENT

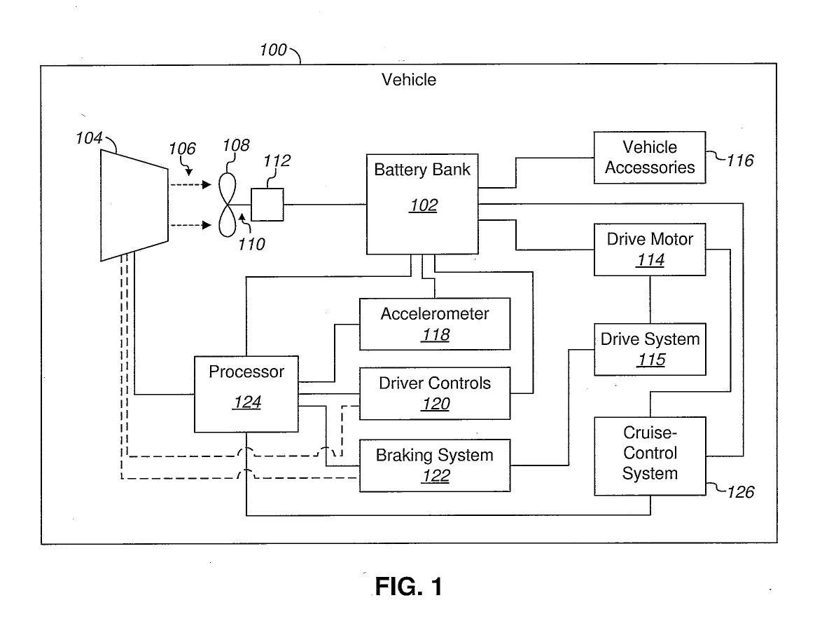

Referring to FIG. 1 in the drawings, a block diagram is shown of a vehicle 100, which can be any type of vehicle. Examples of vehicle types include golf carts, motorcycles, all-terrain vehicles (ATVs), cars, trucks, vans, and sport utility vehicles. It will be appreciated that vehicle 100 can include numerous other conventional vehicle systems and components in addition to those shown in FIG. 1.

The vehicle 100 has a charging system for charging a rechargeable battery bank 102. The battery bank 102 can include one or more rechargeable batteries. In some embodiments, the vehicle is a battery electric vehicle (BEV) that uses chemical energy stored in the rechargeable battery bank for powering an electric motor, which is used instead of, or in combination with, an internal combustion engine for propelling the vehicle. In other embodiments, the vehicle can be a gas powered vehicle that uses an internal combustion engine for propelling the vehicle, but still has a rechargeable battery bank for providing electrical power for starting the engine and for various other systems, such as radios, lights, computers, and other systems requiring electricity to operate. Also, while various components are shown and/or described as part of a vehicle, it should be appreciated that such components can also be located outside of the vehicle, for example on a trailer that is configured to be attached to the vehicle.

The vehicle 100 includes an air inlet 104. The air inlet 104 is configured to direct incoming air 106 in the direction of a fan 108. The incoming air 106 can cause the fan 108 to rotate. The fan 108 is connected, directly or indirectly, to a shaft 110 extending from the rotor of an electrical generator 112, such as an alternator. In some embodiments, the fan 108 can be attached directly to the shaft 110. In other embodiments, the fan 108 can be attached indirectly to the shaft 110. For example, the fan 108 can be connected to the shaft 110 via one or more drive belts, gear boxes, and/or clutches according to methods known by those skilled in the art. In some embodiments, the fan 108 can include one or more fans attached in series or disposed in series on shaft 110. The fan 108 can include any known type of fan, including fans having radially-extending blades and/or centrifugal fans (also referred to as squirrel-cage fans). In some embodiments, the fan 108 can be made of a material that includes one or more of a metal, plastic, or other material that is lightweight and durable.

As the fan 108 rotates, the shaft 110 can cause the rotor of the generator 112 to rotate, resulting in generation of an electric current that can be used to charge the battery bank 102. It will be appreciated by those skilled in the art that additional components can be included as part of the generator 112, battery bank 102, and/or therebetween, for example for power conditioning, timing, and power-surge protection, in order to allow for the battery bank 102 to be safely and properly charged by the generator 112 according to methods known in the art.

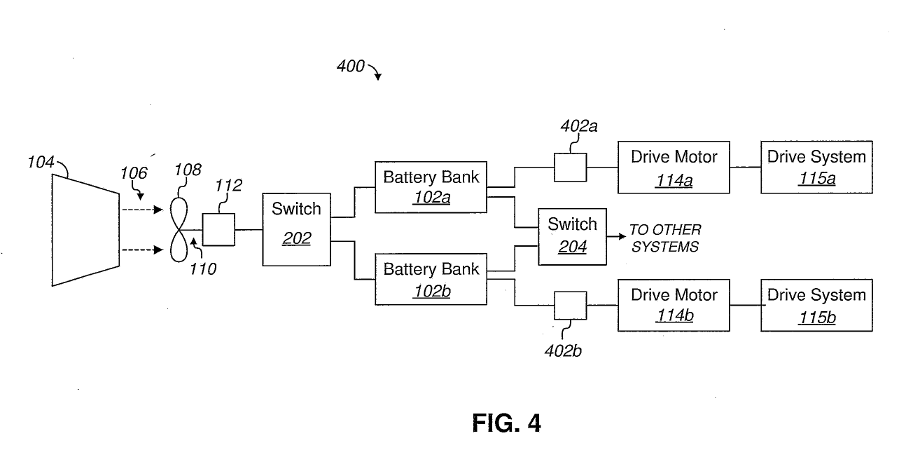

In the illustrated embodiment, the vehicle 100 can use electric power from the battery bank 102 to power an electric drive motor 114 that uses the electric power from the battery bank 102 to produce mechanical energy. For example, the drive motor 114 can be a brushed direct current (DC) motor or a brushless DC motor. In some embodiments, the vehicle 100 can be a hybrid vehicle wherein the drive motor 114 is used in combination with an internal combustion engine for providing mechanical energy to a drive system 115 that is configured for propelling the vehicle 100. In other embodiments, the vehicle 100 can be an electric vehicle wherein the drive motor 114 is for providing mechanical energy to the drive system 115 for propelling the vehicle 100 without another engine. As further described below in connection with FIGS. 3 and 4, the vehicle 100 can include multiple drive motors 114 for providing mechanical energy to one or more drive systems 115 for propelling the vehicle 100.

The drive system 115 can be any conventional drive system that is capable of transferring mechanical energy from the drive motor 114 to one or more drive wheels (not shown). For example, the drive system 115 can include a drive shaft that is rotated by the drive motor 114 through suitable gearing. The drive shaft can be coupled with a driven shaft via a clutch mechanism. The driven shaft can rotate one or more axles attached to one or more drive wheels via a conventional differential mechanism.

The vehicle 100 can also use electric power from the battery bank 102 to power various other vehicle accessories, generally shown and referred to as vehicle accessories 116. The vehicle accessories 116 can include any of a number of known vehicle accessories. Examples of vehicle accessories 116 can include radios, lights, computers, and other systems requiring electricity to operate.

The air inlet 104 can be configured to selectively allow the incoming air 106 to pass therethrough in an open position and prevent the incoming air 106 from passing therethrough in a closed position. For example, the air inlet 104 can include one or more retractable scoops that protrude from the body of the vehicle 100 when the air inlet 104 is in the open position, and are at least substantially flush with the body of the vehicle 100 when the air inlet 104 is in the closed position. In some embodiments, the air inlet 104 can include one or more doors or panels that can be opened and closed in order to selectively allow air to pass through the air inlet 104. For example, the air inlet 104 can include one or more doors or panels that can be controlled to rotate and/or translate between open and closed positions. In some embodiments, the air inlet 104 can include a housing or scoop that includes one or more of plastic, cloth, burlap cloth, fiberglass, hemp cloth, rubber, any light fiber, and metal, including steel or a steel alloy.

The air inlet 104 can be positioned such that air is forced therethrough while the vehicle 100 is moving and the air inlet 104 is in the open position. For example, the air inlet 104 can be positioned such that it opens towards the front of the vehicle 100 so that air is forced into the air inlet 104 while the vehicle is moving forward and the air inlet 104 is in the open position. The exact location of the air inlet 104 can vary, and in some embodiments can depend on a number of factors associated with the vehicle 100. Examples of such factors can include such things as vehicle aerodynamics, vehicle weight and balance, vehicle shape and styling, and locations of other components, such as the respective locations of the drive motor 114, battery bank 102, fan 108, and generator 112. Examples of locations for the air inlet 104 can include the front bumper, grill, fenders, hood, sides, roof, and under-side of the vehicle. In some embodiments, the air inlet 104 can include a protective grill or filter to prevent debris from passing through the air inlet 104.

Also, as mentioned above, in some embodiments, the air inlet 104 can be located separate from the vehicle 100, for example on a trailer that can be connected to and towed by the vehicle 100. In such embodiments, the fan 108 and generator 112 can also be located proximate to the air inlet 104, for example on the same trailer. The generator 112 can then transfer electric power to the battery bank 102 on the vehicle 100 via a wiring harness that includes a connector that can be connected and disconnected between the trailer and the vehicle 100. Alternatively, in such embodiments, the fan 108, generator 112, and battery bank 102 can be located proximate to the air inlet 104, for example on the same trailer. The battery bank 102 can then transfer electric power to the vehicle accessories 116 and/or drive motor 114 on the vehicle 100 via a wiring harness that includes a connector that can be connected and disconnected between the trailer and the vehicle 100; the battery bank 102 can also, or alternatively, be used to provide electric power for trailer components such as lights, tools, machinery, heating systems, and/or cooling systems.

In some embodiments, the air inlet 104 can be fixed such that it remains in the open position. This allows incoming air 106 to pass through the air inlet 104 whenever the vehicle 100 is moving. However, if the vehicle 100 is moving forward, and the incoming air 106 is passing through the air inlet 104 as a result of air being forced through the air inlet 104 by the forward motion of the vehicle 100, an additional amount of drag is created since the incoming air 106 is forced to turn the fan 108 rather than being allowed to pass over the body of the vehicle 100.

In other embodiments, the vehicle 100 can include any one, or any combination, of a number of systems for controlling the air inlet 104 to move between the open position and the closed positions. Examples of such systems for controlling the position of the air inlet 104 include systems that control the air inlet 104 such that the air inlet 104 is moved to the open position whenever extra drag is desirable, and the air inlet 104 is moved to the closed position whenever extra drag is not desirable. More specific examples include systems shown in FIG. 1, including an accelerometer 118, driver controls 120, a braking system 122, and a cruise-control system 126, any one or combination of which can be used in combination with a processor 124.

The accelerometer 118 can include one or more of any devices suitable for detecting and/or measuring acceleration and/or deceleration of the vehicle 100. The presence and/or degree of acceleration and/or deceleration can then be used to determine a suitable position for the air inlet 104. There are many well-known devices that are capable of measuring acceleration and/or deceleration and can be used for measuring acceleration and/or deceleration of the vehicle 100. In some embodiments, such as the illustrated embodiment in FIG. 1, the accelerometer 118 can operate using electric power received from the battery bank 102. In other embodiments, the accelerometer 118 can operate using a different power source in combination with, or instead of, the battery bank 102. The accelerometer 118 can include processor 124, or can communicate with a separate processor 124. In some embodiments, such as the illustrated embodiment in FIG. 1, the processor 124 can operate using electric power received from the battery bank 102. In other embodiments, the processor 124 can operate using a different power source in combination with, or instead of, the battery bank 102. It should be appreciated that in this and other embodiments described herein, communication signals, such as between the processor 124 and the accelerometer 118 or between other components can include wired and/or wireless communications, and that wired communications can be implemented using a wide variety of known communication conduits, including conductive wiring and/or fiber optic wiring. In some embodiments, the accelerometer 118 can include, in place of or in combination with an actual acceleration and/or deceleration measuring and/or detecting device, means for measuring and/or detecting some other aspect or aspects of the vehicle 100 that can be used to derive information representative of a detection or measure of acceleration and/or deceleration of the vehicle 100.

For example, in some embodiments, the accelerometer 118 can be configured to detect and/or measure the speed of the vehicle 100 and use the speed information in place of, in combination with, or for determining acceleration information about the vehicle 100 using known techniques for determining acceleration based on changes in speed. Many vehicles include well-known systems for determining the speed of the vehicle and display the determined speed information to the driver via a speedometer. In some embodiments, such speed-determination systems can constitute at least a portion of accelerometer 118. For example, the speed information can be provided from a speed-determination system to the accelerometer 118, which can use the speed information to calculate and/or verify a separately-calculated acceleration of the vehicle 100 using known techniques for determining acceleration based on changes in speed. Alternatively, the speed information can be provided from a speed-determination system to processor 124, which can use the speed information to determine whether the vehicle 100 is accelerating or decelerating using known techniques for determining acceleration based on changes in speed.

As another example, the accelerometer 118 can detect and/or measure locations and/or changes in locations of the vehicle 100 and use the location information and/or location-change information in place of, in combination with, or for determining acceleration information about the vehicle 100 using known techniques for determining acceleration based on changes in position. There are many well known systems that are capable of detecting and/or measuring locations and/or changes in locations that can be used for detecting and/or measuring locations and/or changes in locations of the vehicle 100. Examples of such systems include Global Positioning Satellite (GPS) systems, which receive and process signals from global positioning satellites to determine a location and/or changes in location over time. Other examples include cellular systems, which can determine location and/or changes in location by triangulating on nearby cell towers having known, fixed positions and/or GPS systems. In some embodiments, such systems can constitute at least a portion of accelerometer 118. For example, the location information and/or location-change information can be provided to accelerometer 118, which can use the location information and/or location-change information to calculate and/or verify a separately-calculated acceleration of the vehicle 100 using known techniques for determining acceleration based on changes in position. Alternatively, the location information and/or location-change information can be provided directly to processor 124, which can use the location information and/or location-change information to determine whether the vehicle 100 is accelerating or decelerating using known techniques for determining acceleration based on changes in position.

The driver controls 120 can include one or more of any devices suitable for allowing a driver and/or passenger in the vehicle 100 to set, adjust, or request a position of the air inlet 104. The input from the driver controls 120 can then be used by the processor 124 to determine a suitable position for the air inlet 104. There are many well-known devices that are capable of receiving an input from a driver and/or passenger and converting the input into information that can be interpreted by the processor 124. For example, the driver controls 120 can include one or more buttons, knobs, pedals, levers, triggers, and/or microphones. The driver controls 120 can also include one or more sensors and/or processors for detecting and/or processing user inputs to the driver controls 120 and transferring information representative of the user inputs to the processor 124.

In some embodiments, such as the illustrated embodiment in FIG. 1, the driver controls 120 can operate using electric power received from the battery bank 102. In other embodiments, the driver controls 120 can operate using a different power source in combination with, or instead of, the battery bank 102. The driver controls 120 can include processor 124, or can communicate with a separate processor 124. In some embodiments, such as the illustrated embodiment in FIG. 1, the processor 124 can operate using electric power received from the battery bank 102. In other embodiments, the processor 124 can operate using a different power source in combination with, or instead of, the battery bank 102.

In some embodiments, the driver controls 120 can include one or more devices for setting and/or adjusting a position of the air inlet 104 without the use of processor 124. For example, the driver controls 120 can include mechanical and/or hydraulic systems that set and/or adjust the position of the air inlet 104 based on input received by the driver controls 120. In some such embodiments, the driver controls 120 can operate without the need for electric power. For example, the driver controls 120 can include a handle or lever that is mechanically connected to the air inlet 104, e.g., via a series of one or more mechanical links, so that the position of the air inlet 104 can be adjusted and/or set without the need for processor 124 and electric power.

The braking system 122 can include a conventional air or hydraulic braking system for slowing and stopping a vehicle. Such conventional braking systems typically include a brake pedal, but in some cases include a brake lever, such as in the case of motorcycles. For convenience, this description will simply refer to brake pedals, but it should be understood that references to brake pedals are intended to include other types of brake controls including brake levers. Since additional drag can be desirable while braking, the braking system 122 can be used to control the position of the air inlet 104 to move to the open position while braking. For example, the air inlet 104 can be moved to the open position while the driver is pressing the brake pedal, and the air inlet 104 can be moved to the closed position while the driver is not pressing on the brake pedal.

There are many ways in which the braking system 122 can be used to control the position of the air inlet 104.

In some embodiments, one or more brake sensors can be used to detect when the brake pedal is pressed. The brake sensors can notify the processor 124 that the brake pedal is pressed. In response, the processor 124 can move the air inlet 104 to the open position. The brake sensors can also notify the processor 124 once the brake pedal is no longer being pressed. In response, the processor 124 can move the air inlet 104 to the closed position.

In some embodiments, one or more accelerator sensors can be used to detect when an accelerator pedal is pressed, and notify the processor 124 when the accelerator pedal is pressed. In such embodiments, signals from the brake sensors can be used by the processor 124 for detecting a deceleration condition, and in response the processor 124 can move the air inlet 104 to the open position, and signals from the accelerator sensors can be used by the processor 124 for detecting an acceleration condition, and in response the processor can move the air inlet 104 to the closed position. In some embodiments, for example, the processor 124 can move the air inlet 104 to the open position when the brake pedal is pressed (i.e., while the vehicle 100 is decelerating), maintain the air inlet 104 in the open position when the brake pedal is released until the accelerator pedal is pressed (i.e., While the vehicle 100 is coasting from decelerating), move the air inlet 104 to the closed position when the accelerator pedal is pressed (i.e., while the vehicle 100 is accelerating), and maintain the air inlet 104 in the closed position when the accelerator pedal is released (i.e., while the vehicle 100 is coasting from accelerating) until the brake pedal is pressed again. Note that references to an accelerator pedal are intended to include conventional engine acceleration and/or throttle controls, including pedals such as those typically found in cars and trucks, levers such as those typically found on all-terrain vehicles, and twist-grips such as those typically found on motorcycles.

In some embodiments, the air or hydraulic system of the braking system 122 can be used to control the position of the air inlet 104.

In typical hydraulic braking systems, increased hydraulic pressure between a master cylinder and one or more brake calipers is indicative of braking by the driver. In some embodiments, one or more sensors can be used to detect this increased hydraulic pressure and notify the processor 124 of the braking condition. In some embodiments, the hydraulic system can be used to operate one or more pistons, actuators, cams, or the like that are configured for opening and closing the air inlet 104. For example, when the driver presses the brake pedal, the increased hydraulic pressure can cause a piston or actuator to open the air inlet 104; when the driver releases the brake pedal, the decreased hydraulic pressure can cause the piston or actuator to close the air inlet 104.

In typical air braking systems, decreased air pressure in the air system is indicative of braking by the driver. In some embodiments, one or more sensors can be used to detect this decreased air pressure and notify the processor 124 of the braking condition. In some embodiments, the air system can be used to operate one or more pistons, actuators, cams, or the like that are configured for opening and closing the air inlet 104. For example, when the driver presses the brake pedal, the decreased air pressure can cause a piston or actuator to open the air inlet 104; when the driver releases the brake pedal, the increased air pressure can cause the piston or actuator to close the air inlet 104.

In some embodiments, the processor 124 can be a dedicated processor for controlling the air inlet 104. In other embodiments, the processor 124 can be a processor that is also used for other tasks. For example, many vehicles include an engine control unit (ECU) or the like, which monitors numerous sensors throughout the vehicle and controls numerous systems throughout the vehicle. In some embodiments, an ECU or the like can serve as the processor 124. The processor 124 can be configured to control the position of the air inlet 104. For example, the processor 124 can receive input signals from various sensors as described above, for example speed, acceleration, and/or position data; driver input data; and/or data from the braking system.

The processor 124 can include instructions that provide rules for controlling the position of the air inlet 104 based on the various inputs. The rules can include rules based on the various embodiments described herein in connection with the accelerometer 118, driver controls 120, and braking system 122. Examples of such rules can include:
Move the air inlet 104 to the open position if the accelerometer 118 indicates deceleration of the vehicle 100
Move the air inlet 104 to the closed position if the accelerometer 118 indicates acceleration of the vehicle 100
Move the air inlet 104 to the open position if the driver controls 120 indicate an open command from the driver
Move the air inlet 104 to the closed position if the driver controls 120 indicate a closed command from the driver
Move the air inlet 104 to the open position if the braking system 122 indicates that the driver is applying the brakes
Move the air inlet 104 to the closed position if the braking system 122 indicates that the driver is not applying the brakes

The rules can also include rules for prioritizing inputs from different systems. For example, the driver controls 120 can be a highest priority, the accelerometer 118 can be a second-highest priority, and the braking system 122 can be a lowest priority in terms of dictating the position of the air inlet 104. So, for example, if a driver wants to leave the air inlet 104 open during acceleration, the open command from the driver controls 120 will override the acceleration indication from the accelerometer 118, where the acceleration indication from the accelerometer 118 would otherwise cause the processor 124 to close the air inlet 104 according to the rules listed above. The rules can also include rules for handling combinations of otherwise conflicting inputs from different systems in the absence of, or notwithstanding, prioritization rules. Examples of such rules can include:
Move the air inlet 104 to the open position if the braking system 122 indicates that the driver is not applying the brakes but the accelerometer 118 indicates that the vehicle 100 is decelerating (i.e., the vehicle 100 is coasting to a stop)
Move the air inlet 104 to the open position if the braking system 122 indicates that the driver is applying the brakes, but the accelerometer 118 indicates that the vehicle 100 is accelerating (i.e., accelerometer failure or brake system failure)

More sophisticated rules can be provided, for example to prevent rapid opening and closing of the air inlet 104 and/or to account for driver inattention. Examples of such rules can include:
Determine an amount of time since the position of the air inlet 104 was last changed and do not change the position of the air inlet 104 unless a predetermined amount of time has elapsed
Determine an amount of time since the driver provided an input to the driver controls 122 and disregard the driver controls 122 if a predetermined amount of time has elapsed

The predetermined amount of time between position changes can be set to any desired amount of time; for example, an amount of time that allows the air inlet 104 to fully open or fully close before the position of the air inlet 104 is changed again. The predetermined amount of time since driver input can be set to any desired amount of time; for example, an amount of time that prevents excessive drag while driving with the air inlet 104 in the open position. Still further rules can include rules for moving the air inlet 104 to the open position when the vehicle 100 is parked or powered down in order to allow incident wind to enter the air inlet 104 so that the battery bank 102 can be charged while the vehicle 100 is parked or not in use. Still further rules can include rules for closing the air inlet 104 when the battery bank 102 is fully charged and keeping the air inlet 104 closed unless the battery bank 102 needs to be charged.

In some embodiments, the driver controls 120 can include one or more communication devices for communicating information to the driver. Examples of communication devices can include a visual display, such as indicator lights, text, or other visual indicator, and/or an audible alert, such as a tone, computer-generated speech, and/or pre-recorded speech. The communication devices of the driver controls 120 can alert the driver to the current position of the air inlet 104 and/or provide confirmation feedback for inputs provided by the driver. The communication devices of the driver controls 120 can alert the driver when a predetermined amount of time has elapsed since the driver last provided input for opening and/or closing the air inlet 104. The communication devices of the driver controls 120 can alert the driver to the charge level (e.g., fully charged, percent charged, almost or completely discharged) of the battery bank 102.

In some embodiments, the vehicle 100 can include a conventional cruise control system 126 such as one of the many cruise control systems known by those skilled in the art. In some such embodiments, the processor 124 can be configured to receive cruise-control information about the state of the cruise control system 126, which can include driver inputs to the cruise control system 126. In addition to, or instead of, other information and rules described herein, the processor 124 can be configured to control the position of the air inlet 104 based on the cruise-control information. For example, if the processor 124 detects that the cruise control system 126 is ON and SET, meaning that the driver has activated the cruise control system 126 to maintain the vehicle at a set speed, then the processor 124 can move the air inlet 104 to the closed position. Then, if the processor 124 detects that the cruise control system 126 received a COAST input from the driver, meaning that the driver desires the cruise control system 126 to allow the vehicle to decelerate, the processor 124 can move the air inlet 104 to the open position. Then, if the processor 124 detects that the cruise control system 126 received a SET or RESUME input from the driver, meaning that the driver has again instructed the cruise control system 126 to maintain the vehicle at a set speed, then the processor 124 can move the air inlet 104 to the closed position. These and/or other rules can be used by the processor 124 to control the position of the air inlet 104 based at least in part on cruise-control information.

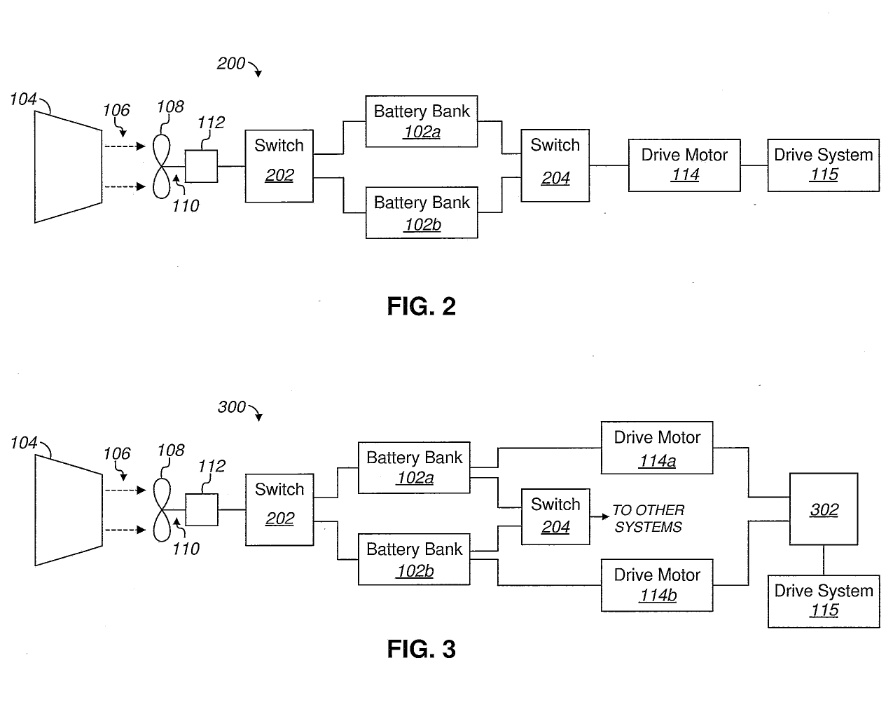

Turning next to FIG. 2, a partial block diagram of an alternative vehicle is shown and generally designated as vehicle 200, which can be any type of vehicle. Examples of vehicle types include golf carts, motorcycles, all-terrain vehicles (ATVs), cars, trucks, vans, and sport utility vehicles. It will be appreciated that vehicle 200 can include numerous other conventional vehicle systems and components in addition to those shown in FIG. 2. The vehicle 200 can be substantially the same as vehicle 100, but has at least a few significant differences. Embodiments of the vehicle 200 can include, in addition to the components shown in FIG. 2, one or more of the vehicle accessories 116, accelerometer 118, driver controls 120, braking system 122, processor 124, and cruise control system 126 shown in FIG. 1 and described above.

As shown in FIG. 2, the vehicle 200 can include a plurality of battery banks 102, including a first battery bank 102a and a second battery bank 102b. In alternative embodiments, the vehicle 200 can include any number of battery banks 102 in addition to the first and second battery banks 102a and 102b. The vehicle 200 allows for one or more battery banks 102 to be charged while one or more other battery banks 102 are used to provide electric power for one or more systems of the vehicle 200.

The vehicle 200 includes a charge switch 202 for controlling which of the battery banks 102 will be charged by the generator 112. There are many suitable known switches, including relays, that can be used as the charge switch 202. In some embodiments, the charge switch 202 can be configured to select one of the plurality of battery banks 102 to be charged. In some embodiments, the charge switch 202 can be configured to select one or more of the plurality of battery banks 102 to be simultaneously charged.

The vehicle 200 also includes a power-source switch 204 for controlling which of the battery banks 102 will provide electric power to the drive motor 114. The power-source switch 204 can also be used to control which of the battery banks 102 will provide electric power to other systems, including one or more of the vehicle accessories 116, accelerometer 118, driver controls 120, braking system 122, processor 124, and cruise control system 126 in embodiments so equipped. There are many suitable known switches, including relays, that can be used as the power-source switch 204.

In some embodiments, the charge switch 202 and the power-source switch 204 can be directly controllable by the driver. For example, the vehicle 200 can include driver controls for allowing the driver or a passenger to operate the charge switch 202 and/or the power-source switch 204. The vehicle 200 can also include a display of the charge levels of the battery banks 102 so that the driver can make an informed decision about which of the battery banks 102 to charge and which of the battery banks 102 to use as a power source.

In some embodiments, the charge switch 202 and the power-source switch 204 can be automatically controlled by the processor 124. For example, the processor 124 can be configured to monitor the charge levels of the battery banks 102. This allows the processor 124 to set the charge switch 202 and the power-source switch 204 based on information about the battery banks 102. For example, the processor 124 can be configured to set the charge switch 202 to charge the battery bank 102 having the lowest charge level, and the processor 124 can be configured to set the power-source switch 204 to set the power-source switch 204 to use the battery bank 102 having the highest charge level for providing electric power for one or more systems of the vehicle 200.

Turning next to FIG. 3, a partial block diagram of an alternative vehicle is shown and generally designated as vehicle 300, which can be any type of vehicle. Examples of vehicle types include golf carts, motorcycles, all-terrain vehicles (ATVs), cars, trucks, vans, and sport utility vehicles. It will be appreciated that vehicle 300 can include numerous other conventional vehicle systems and components in addition to those shown in FIG. 3. The vehicle 300 can be substantially the same as vehicle 100, but has at least a few significant differences. Embodiments of the vehicle 300 can include, in addition to the components shown in FIG. 3, one or more of the vehicle accessories 116, accelerometer 118, driver controls 120, braking system 122, processor 124, and cruise control system 126 shown in FIG. 1 and described above.

The vehicle 300 allows for one or more battery banks 102 and respective drive motors 114 to be used for propelling the vehicle 300, while the generator 112 charges one or more other battery banks 102 corresponding to one or more other respective drive motors 114. As shown in FIG. 3, the vehicle 300 can include a plurality of battery banks 102, including a first battery bank 102a and a second battery bank 102b. In alternative embodiments, the vehicle 300 can include any number of battery banks 102 in addition to the first and second battery banks 102a and 102b. The vehicle 300 also includes a plurality of drive motors 114, including a first drive motor 114a and a second drive motor 114b. In alternative embodiments, the vehicle 300 can include any number of drive motors 114 in addition to the first and second drive motors 114a and 114b. The vehicle 300 includes a battery bank 102 for each drive motor 114. In alternative embodiments, the vehicle 300 can include multiple battery banks 102 for each drive motor 114 in a manner substantially the same as described above in connection with FIG. 2.

The vehicle 300 includes a charge switch 202 for controlling which of the battery banks 102 will be charged by the generator 112. The charge switch 202 can be substantially identical to the charge switch 202 of the vehicle 200, and therefore the same reference numeral is shown in FIG. 3. Also, the description of the charge switch 202 provided above in connection with vehicle 200 applies equally to the charge switch 202 of vehicle 300.

The vehicle 300 also includes a differential 302 or other mechanical energy distribution device for controlling which of the drive motors 114 will provide mechanical energy to the drive system 115.

The vehicle 300 can also include a power-source switch 204 for controlling which of the battery banks 102 will provide electric power to other systems, including one or more of the vehicle accessories 116, accelerometer 118, driver controls 120, braking system 122, processor 124, and cruise control system 126 in embodiments so equipped. The power-source switch 204 can be substantially identical to the power-source switch 204 of the vehicle 200, and therefore the same reference numeral is shown in FIG. 3. Also, the description of the power-source switch 204 provided above in connection with vehicle 200 applies equally to the power-source switch 204 of vehicle 300.

Turning next to FIG. 4, a partial block diagram of an alternative vehicle is shown and generally designated as vehicle 400, which can be any type of vehicle. Examples of vehicle types include golf carts, motorcycles, all-terrain vehicles (ATVs), cars, trucks, vans, and sport utility vehicles. It will be appreciated that vehicle 400 can include numerous other conventional vehicle systems and components in addition to those shown in FIG. 4. The vehicle 400 can be substantially the same as vehicle 100, but has at least a few significant differences. Embodiments of the vehicle 400 can include, in addition to the components shown in FIG. 4, one or more of the vehicle accessories 116, accelerometer 118, driver controls 120, braking system 122, processor 124, and cruise control system 126 shown in FIG. 1 and described above.

The vehicle 400 allows for one or more battery banks 102, respective drive motors 114, and respective drive systems 115 to be used for propelling the vehicle 300, while the generator 112 charges one or more other battery banks 102 corresponding to one or more other respective drive motors 114 and drive systems 115. As shown in FIG. 4, the vehicle 400 can include a plurality of battery banks 102, including a first battery bank 102a and a second battery bank 102b. In alternative embodiments, the vehicle 400 can include any number of battery banks 102 in addition to the first and second battery banks 102a and 102b. The vehicle 400 also includes a plurality of drive motors 114, including a first drive motor 114a and a second drive motor 114b. In alternative embodiments, the vehicle 400 can include any number of drive motors 114 in addition to the first and second drive motors 114a and 114b. The vehicle 400 further includes a plurality of drive systems 115, including a first drive system 115a and a second drive system 115b. In alternative embodiments, the vehicle 400 can include any number of drive systems 115 in addition to the first and second drive systems 115a and 115b. The vehicle 400 includes a drive system 115 for each battery bank 102 and respective drive motor 114. In alternative embodiments, the vehicle 400 can include multiple battery banks 102 for each drive motor 114 and respective drive system 115 in a manner substantially the same as described above in connection with FIG. 2.

The vehicle 400 includes a charge switch 202 for controlling which of the battery banks 102 will be charged by the generator 112. The charge switch 202 can be substantially identical to the charge switch 202 of the vehicle 200, and therefore the same reference numeral is shown in FIG. 4. Also, the description of the charge switch 202 provided above in connection with vehicle 200 applies equally to the charge switch 202 of vehicle 400.

The vehicle 400 can also include a plurality of power switches 402, including a respective power switch 402 for each battery bank 102/drive motor 114/drive system 115 group. For example, as shown in FIG. 4, the vehicle 400 can include a first power switch 402a for controlling power from the battery bank 102a to drive motor 114a, and a second power switch 402b for controlling power from the battery bank 102b to drive motor 114b. The power switches 402 can be controlled by the processor 124 so that power to a drive motor 114 and drive system 115 can be disconnected while the respective battery bank 102 is charging and/or according to input from the driver of the vehicle 400.

The vehicle 400 can also include a power-source switch 204 for controlling which of the battery banks 102 will provide electric power to other systems, including one or more of the vehicle accessories 116, accelerometer 118, driver controls 120, braking system 122, processor 124, and cruise control system 126 in embodiments so equipped. The power-source switch 204 can be substantially identical to the power-source switch 204 of the vehicle 200, and therefore the same reference numeral is shown in FIG. 4. Also, the description of the power-source switch 204 provided above in connection with vehicle 200 applies equally to the power-source switch 204 of vehicle 400.

According to some embodiments, the vehicle 400 can be a four-wheel vehicle, such as an ATV, golf cart, car, or truck. The first battery bank 102a, drive motor 114a, and drive system 115a can be configured for rotating the left rear wheel. The second battery bank 102b, drive motor 114b, and drive system 115b can be configured for rotating the right rear wheel. The driver can choose to drive the vehicle 400 using the left rear wheel, but not the right rear wheel, by issuing an appropriate input to the processor 124. In response, the processor 124 can be configured to close the power switch 402a and open the power switch 402b so that electric power is provided to the drive motor 114a from the battery bank 102a, but electric power is not provided to the drive motor 114b from the battery bank 102b. The processor 124 can also control the charge switch 202 to allow the battery bank 102b to be charged by the generator 112. The driver can similarly choose to drive the vehicle 400 using only the right rear wheel. The driver can also choose to drive the vehicle 400 using both rear wheels by issuing an appropriate input to the processor 124. In response, the processor 124 can be configured to close both the power switch 402a and the power switch 402b so that electric power is provided to the drive motor 114a from the battery bank 102a and electric power is provided to the drive motor 114b from the battery bank 102b.

Alternative embodiments of the vehicle 400 can involve other wheels, for example front wheels rather than rear wheels. Alternative embodiments can also involve vehicles having any number wheels. For example, the vehicle 400 can have four, six, or more wheels, where one or more of the wheels can be independently driven by a respective a battery bank 102/drive motor 114/drive system 115 group. Alternatively, one or more of the battery bank 102/drive motor 114/drive system 115 groups can be used to drive two or more wheels. For example, the battery bank 102a, drive motor 114a, and drive system 115a can be used to drive the front two wheels, while the battery bank 102b, drive motor 114b, and drive system 115b can be used to drive the rear two wheels.

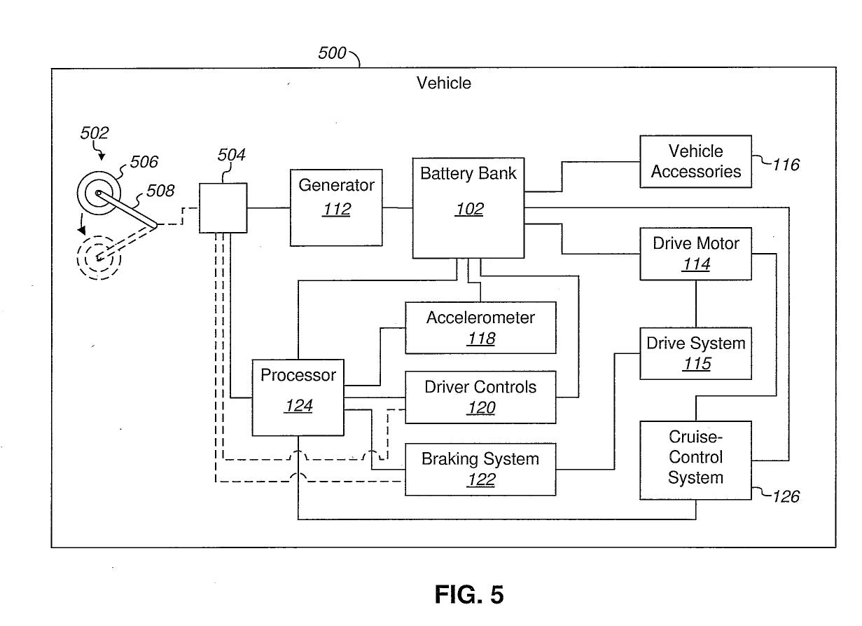

Turning next to FIG. 5, a block diagram of an alternative vehicle is shown and generally designated as vehicle 500, which can be any type of vehicle. Examples of vehicle types include golf carts, motorcycles, all-terrain vehicles (ATVs), cars, trucks, vans, and sport utility vehicles. It will be appreciated that vehicle 500 can include numerous other conventional vehicle systems and components in addition to those shown in FIG. 5. The vehicle 500 can be substantially the same as vehicle 100, but has at least a few significant differences. Embodiments of the vehicle 500 can include a battery bank 102 and a generator 112 as described above, as well as one or more of the vehicle accessories 116, accelerometer 118, driver controls 120, braking system 122, processor 124, and cruise control system 126 shown in FIG. 1 and described above.

The vehicle 500 also includes a drop-wheel assembly 502 and a drop-wheel controller 504. The drop-wheel assembly 502 includes a wheel 506 and a wheel support 508. The drop-wheel controller 504 is operably associated with the wheel support 508 such that the drop-wheel controller 504 can control the position of the wheel 506 between a retracted position and an extended position. In the extended position, the wheel 506 is in contact with the ground; in the retracted position, the wheel 506 is lifted away from the ground.

When the wheel 506 is in the extended position, the wheel 506 will turn while the vehicle 500 is moving. The wheel 506 is operably associated with the generator 112 such that rotation of the wheel 506 causes rotation of the rotor 110 of the generator 112. In some embodiments, the generator 112 can be supported by the wheel support 508. This allows the rotor 110 of the generator 112 to be in closer proximity to the wheel 506, allowing for a simpler transfer of rotational energy from the wheel 506 to the rotor 110 of the generator 112.

In some embodiments, the wheel 506 can be fixed in the extended position rather than being retractable. However, the wheel 506 causes additional drag that can reduce the performance and efficiency of the vehicle 100. Thus, in other embodiments, the vehicle 500 can include any one, or any combination, of a number of systems for instructing the drop-wheel controller 504 to move the wheel 506 between the extended position and the retracted positions. Examples of such systems for instructing the drop-wheel controller 504 to extend or retract the wheel 506 include systems that instruct the drop-wheel controller 504 such that the wheel 506 is moved to the extended position whenever extra drag is desirable, and the wheel 506 is moved to the retracted position whenever extra drag is not desirable. More specific examples include systems shown and described above, including an accelerometer 118, driver controls 120, a braking system 122, and a cruise control system 126, any one or combination of which can be used in combination with a processor 124 as described above for determining whether to reposition the wheel 506 (as opposed to the inlet 104), for example by determining whether excess drag is desirable and/or undesirable according to any of the embodiments described above.

Alternative embodiments of the vehicle 500 can include multiple battery banks 102 as described above in connection with FIG. 2; can include multiple battery banks 102 for providing electric power to respective drive motors 114 as described above in connection with FIG. 3; and/or can include multiple battery banks 102 for providing electric power to respective drive motors 114 for powering respective drive systems 115 as described above in connection with FIG. 4.

Still further embodiments of any of the vehicles described herein can include combinations of one or more fixed and/or repositionable air inlets 104 and/or drop-wheel assemblies 502. Still further embodiments of any of the vehicles described herein can also include additional electric charging systems for charging one or more battery banks 102, for example one or more solar panels, manual (e.g., hand-crank) generators, generators driven by an internal combustion engine, or other known system for generating electricity. Still further embodiments of any of the vehicles described herein can also include a drive system 115 that has a drive shaft connected, directly or indirectly, to the rotor of a generator or alternator for charging one or more battery banks 102. Still further embodiments of any of the vehicles described herein can also include a drive system 115 that has an axle connected, directly or indirectly, to the rotor of a generator or alternator for charging one or more battery banks 102. Still further embodiments of any of the vehicles described herein can include a kill switch for turning off all electric power in the event of an accident. Still further embodiments of any of the vehicles described herein can include venting for providing ventilation for the one or more battery banks 102. Still further embodiments of any of the vehicles described herein can include a compartment for the one or more battery banks 102 located underneath one or more passenger or driver seats.

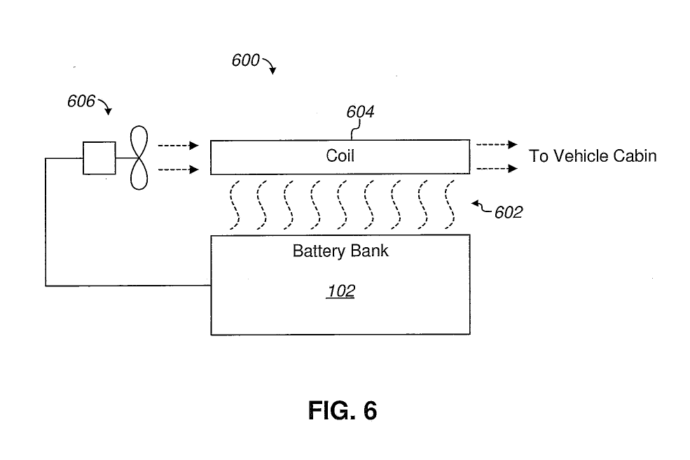

Turning next to FIG. 6, a block diagram of a heating system 600 is shown that can be used with any of the vehicles described herein, or elsewhere. It is also desirable to utilize systems that require as little electricity as possible in the vehicles described herein, so as to maximize the effective use of the battery banks 102. This is especially true for embodiments that are purely electric vehicles. In vehicles having an internal combustion engine, the heat of the engine is typically used for providing the heat used for the cabin heater of the vehicle. Thus, such conventional systems cannot be used on electric vehicles that lack an internal combustion engine. One alternative would be to use electricity to heat a coil, but such systems would require a large amount of electricity, significantly increasing the discharge time for the battery banks 102.

The heating system 600 provides a solution for this problem. Many batteries that can be used as battery bank 102 produce radiant heat (represented generally as broken lines 602) while in use, i.e., discharging. The heating system 600 includes a heating coil 604 disposed in close proximity to the battery bank 102. In some embodiments, the battery bank 102 can be representative of any number of batteries or battery banks 102, and one or more heating coils 604 can be disposed in close proximity thereto. Other components of the heating system 600 can be similar to conventional heating systems. For example, a blower fan 606, which in some embodiments can be powered by the battery bank 102, can be used to blow air across the coils 604 and into a duct system to the vehicle cabin. The blower fan 606 can be controlled in a manner similar to conventional heating systems to allow the driver to turn the blower fan 606 on, off, and to one of multiple speeds.

As mentioned above, still further embodiments of any of the vehicles described herein can also include a drive system 115 that has a drive shaft connected, directly or indirectly, to the rotor of one or more electrical generators 112 for charging one or more battery banks 102 and/or providing electrical power directly to the drive system 115; and still further embodiments of any of the vehicles described herein can also include a drive system 115 that has an axle connected, directly or indirectly, to the rotor of one or more electrical generators 112 for charging one or more battery banks 102 and/or providing electrical power directly to the drive system 115.

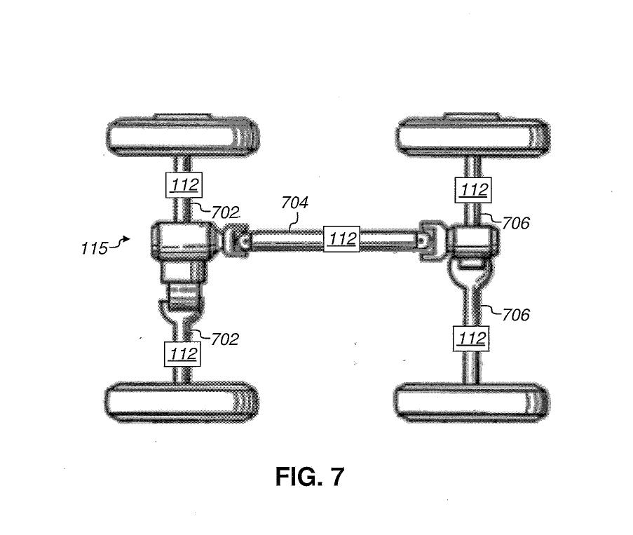

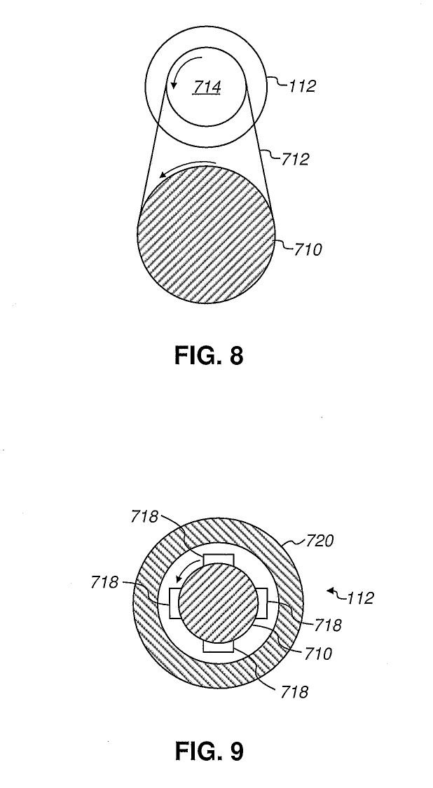

FIG. 7 shows a drive system 115 for driving an axle 702 and/or a drive shaft 704, which in turn drives an axle 706. Each of the axle 702, drive shaft 704, and axle 706 includes one or more respective shafts that rotate as they are driving by the drive system 115. However, in some embodiments the drive shaft 704 and/or one or both of the axles 702 and 706 can include a free-wheeling shaft that rotates with the rotation of one or more wheels rather than being driven directly by the drive system 115. The rotation of the shafts can be used to drive one or more electric generators 112 that have a rotating element driven by the shaft and a stationary element supported by the vehicle chassis 708. As shown in FIG. 7, one or more of the axle 702, drive shaft 704, and axle 706 can be operably associated with respective electric generators 112. In some embodiments, for example as shown in FIG. 8, one or more electric generators 112 can be belt, strap, or chain driven by the axle 702, drive shaft 704, and/or axle 706 for generating electricity. In alternative embodiments, for example as shown in FIG. 9, the electric generators 112 can use the axle 702, drive shaft 704, and/or axle 706 as a component thereof for generating electricity.

The system shown in FIG. 7 can also include one or more static collection wires 710. The static collection wires 710 can include exposed electrically-conductive material for collecting static electricity from the atmosphere due to friction between the wires 710 and the surrounding air while the vehicle is moving.

In some embodiments, the electric generators 112 and/or static collection wires 710 can provide electrical power for charging one or more battery banks 102 part of the time, and the electric generators 112 can provide electrical power directly to the drive system 115 part of the time. For example, the electric generators 112 can provide electrical power for charging one or more battery banks 102 at relatively lower vehicle speeds, such as under 50mph, and the electric generators 112 can transition to providing electrical power directly to the drive system 115 at relatively higher speeds, for example above 50mph or at highway speeds. The transition from providing electrical power for charging one or more battery banks 102 to providing electrical power directly to the drive system 115 or vice-versa can be automatic based on predefined rules, such as ranges of vehicle speeds, or can be manually-controlled, for example by the driver operating driver controls.

FIG. 8 shows an embodiment of an operable association between an electric generator 112 and any one of the axle 702, driveshaft 704, and axle 706. FIG. 8 shows a cross-sectional view of a shaft 710, which can be a shaft of any of the axle 702, driveshaft 704, and axle 706. In the illustrated embodiment, the shaft 710 is operably associated with an electric generator 112 by a drive belt 712. The drive belt 712 extends around the shaft 710 and a flywheel 714 of the electric generator 112. As the shaft 710 rotates, the belt 712 is sufficiently tensioned around the shaft 710 and flywheel 714 that the rotation of the shaft 710 causes rotation of the flywheel 714 by the drive belt 712. The flywheel 714 is connected to a stator of the electric generator 112 so that rotation of the flywheel 714 can result in electricity being generated by the electric generator 112.

FIG. 9 shows an embodiment of an operable association between an electric generator 112 and any one of the axle 702, driveshaft 704, and axle 706. FIG. 9 shows a cross-sectional view of a shaft 710, which can be a shaft of any of the axle 702, driveshaft 704, and axle 706. In the illustrated embodiment, the shaft 710 is operably associated with an electric generator 112 by serving as a stator for the electric generator 112. The shaft 710 includes one or more brushes 718 of the type commonly known for electric generators. The electric generator 112 includes a housing 720 that is supported by the vehicle chassis 708 (shown in FIG. 7) and is fixed in place relative to the shaft 710. The housing 720 extends concentrically about the shaft 710. As the shaft 710 rotates, the shaft 710 with the one or more brushes 718 serves as a stator for the electric generator 112, the housing 720 of which remains fixed rather than rotating. Thus, rotation of the shaft 710 with the brushes 718 fixed thereto can result in electricity being generated by the electric generator 112.

It will be apparent to those skilled in the art that an invention with significant advantages has been described and illustrated. Although the present application is shown in a limited number of forms, it is not limited to just these forms, but is amenable to various changes and modifications without departing from the spirit thereof.

What is claimed is:

1. A vehicle comprising:
a battery bank having one or more batteries capable of storing an electric charge;
a drive system that rotates a shaft for moving the vehicle; and
an electricity generating system for generating electricity and providing the generated electricity to the battery bank for charging one or more batteries of the battery bank,
wherein the electricity generating system is operably associated with the shaft such that rotation of the shaft causes the electricity generating system to generate electricity.

2. The vehicle of claim 1, wherein the electricity generating system is operably associated with the shaft by a drive belt that extends about the shaft and about a flywheel of the electricity generating system.

3. The vehicle of claim 1, wherein the electricity generating system includes a housing that extends concentrically about the shaft.

4. The vehicle of claim 3, wherein the housing is fixed relative to the shaft and the shaft rotates relative to the housing.

5. The vehicle of claim 3, wherein shaft includes one or more brushes attached thereto within the housing.

6. The vehicle of claim 1, further comprising:
a movable member configured for providing energy to the electricity generating system while the movable member is moved by an external force that is external to the vehicle, wherein the electricity generating system can generate electricity while receiving energy from the movable member; and
a control system for controlling whether the movable member is exposed to the external force.

7. The vehicle of claim 6, Wherein the movable member includes a fan.

8. The vehicle of claim 7, further comprising an air inlet for directing incoming air towards the fan, wherein the control system can control the air inlet in order to control whether the fan is exposed to an external force produced by the incoming air.

9. The vehicle of claim 8, wherein the control system is configured to allow a driver of the vehicle to manually move the air inlet to an open position and to a closed position, wherein the, open position allows the fan to be exposed to incoming air, and the closed position reduces the amount of incoming air to which the fan is exposed as compared to the open position.

10. The vehicle of claim 8, wherein the control system comprises a processor configured to control the air inlet to move to an open position and to a closed position, wherein the open position allows the fan to be exposed to incoming air, and the closed position reduces the amount of incoming air to which the fan is exposed as compared to the open position.

11. The vehicle of claim 10, further comprising at least one of an accelerometer configured to provide vehicle information to the processor, a driver control configured to provide vehicle information to the processor, a braking system configured to provide vehicle information to the processor, and a cruise-control system configured to provide vehicle information to the processor, wherein the processor is configured to control the air inlet based at least in part on the vehicle information.

12. The vehicle of claim 6, wherein the movable member includes a wheel.

13. The vehicle of claim 12, further comprising a drop-wheel controller for controlling whether the wheel is in contact with the ground, thereby allowing the drop-wheel controller to control whether the wheel is exposed to an external force that results from the relative movement between the ground and the vehicle.

14. The vehicle of claim 13, wherein the drop-wheel controller is configured to allow a driver of the vehicle to manually move the wheel to an extended position and to a retracted position, wherein the extended position allows the wheel to make contact with the ground, and the retracted position maintains the wheel away from making contact with the ground.

15. The vehicle of claim 13, wherein the control system comprises a processor configured to control the drop-wheel controller to move the wheel to an extended position and to a retracted position, wherein the extended position allows the wheel to make contact with the ground, and the retracted position maintains the wheel away from making contact with the ground.

16. The vehicle of claim 15, further comprising at least one of an accelerometer configured to provide vehicle information to the processor, a driver control configured to provide vehicle information to the processor, a braking system configured to provide vehicle information to the processor, and a cruise-control system configured to provide vehicle information to the processor, wherein the processor is configured to control the drop-wheel controller based at least in part on the vehicle information.

17. The vehicle of claim 16, wherein the battery bank is a first battery bank and the vehicle further comprises a second battery bank and first and second electric drive motors, wherein the first battery bank is configured to provide electric power to the first electric drive motor and the second battery bank is configured to provide electric power to the second electric drive motor.

18. A method of charging a battery of a vehicle, the method comprising:
providing a movable member;
controlling the exposure of the movable member to an external force, including increasing the exposure of the movable member to the external force at least during vehicle deceleration and reducing the exposure of the movable member to the external force at least during vehicle acceleration; and
using mechanical energy from the movable member, generating electrical power for recharging the battery while the movable member is exposed to the external force.

19. The method of claim 19, wherein the movable member includes a fan, and wherein the controlling of the exposure of the movable member to an external force includes opening an air inlet at least during vehicle deceleration and closing the air inlet at least during vehicle acceleration.

20. The method of claim 18, wherein the movable member includes a wheel, and wherein the controlling of the exposure of the movable member to an external force includes extending the wheel at least during vehicle deceleration and retracting the wheel at least during vehicle acceleration.
